(19) United States
(12) Patent Application Publication
(10) Pub. No.: US 2026/0103235 A1
(43) Pub. Date: Apr. 16, 2026

(54) CONTROL DEVICE, MOTOR DEVICE, ELECTRIC POWER STEERING DEVICE, CONTROL METHOD, AND PROGRAM

(71) Applicant: NIDEC CORPORATION, Kyoto (JP)

(72) Inventors: Shuji ENDO, Kyoto (JP); Sota TANAKA, Kyoto (JP)

(21) Appl. No.: 19/353,882

(22) Filed: Oct. 9, 2025

Related U.S. Application Data
(60) Provisional application No. 63/705,666, filed on Oct. 10, 2024.

(30) Foreign Application Priority Data
Jan. 17, 2025 (JP) 2025-006991

(51) Int. Cl. B62D 5/04

(52) U.S. Cl. CPC B62D 5/0463; B62D 5/0421

(57) ABSTRACT

A control device includes an assist controller configured or programmed to generate an input torque input to a control target based on a torsion bar torque, a model following controller configured or programmed to generate a correction torque to correct the input torque based on a nominal model, a vibration torque generator configured or programmed to generate a vibration torque, and a gain adjuster configured or programmed to adjust a vibration torque gain to be multiplied by the vibration torque. The vibration torque multiplied by the vibration torque gain is added to the input torque. The model following controller is configured or programmed to calculate an estimated value of a self-aligning torque to be applied to the control target, and generate a correction torque based on the estimated value. The gain adjuster is configured or programmed to increase the vibration torque gain as the estimated value increases.

### CROSS-REFERENCE TO RELATED APPLICATIONS

The present application is a non-provisional application of U.S. Patent Application No. 63/705,666, filed on Oct. 10, 2024, and claims priority under 35 U.S.C. § 119 to Japanese Patent Application No. 2025-006991, filed on Jan. 17, 2025, the entire contents of which are hereby incorporated herein by reference.

### 1. FIELD OF THE INVENTION

The present disclosure relates to control devices, motor devices, electric power steering devices, control methods, and non-transitory computer-readable media including programs.

### 2. BACKGROUND

An electric power steering system mounted on a vehicle is known.

A vehicle equipped with the electric power steering system as described above may be equipped with a lane departure warning system (LDWS) that gives a warning to a steering person when the vehicle is likely to deviate from a lane. In this case, the electric power steering system may generate a vibration torque based on a command signal from the lane departure warning device, and give a warning to the steering person by vibrating the steering wheel. However, such a vibration torque is less likely to appear in the steering torque as the torque assisted by the electric power steering system increases. Therefore, there is a problem that the magnitude of the vibration torque transmitted to the steering person changes depending on the traveling state or the like of the vehicle. Therefore, there is a problem that it is difficult for a steering person to accurately grasp the warning provided by the vibration torque.

### SUMMARY

A control device according to an example embodiment of the present disclosure controls, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft. The control device includes an assist controller configured or programmed to generate an input torque to be input to the control target based on a torsion bar torque generated in the torsion bar, a model following controller configured or programmed to generate a correction torque to correct the input torque based on a nominal model based on a configuration of the control target, a vibration torque generator configured or programmed to generate a vibration torque based on a command signal from the vehicle, and a gain adjuster configured or programmed to adjust a vibration torque gain to be multiplied by the vibration torque. The vibration torque multiplied by the vibration torque gain is added to the input torque. The model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model. The model following controller is configured or programmed to calculate an estimated value of a self-aligning torque to be applied to the control target, and generate the correction torque based on the estimated value. The gain adjuster is configured or programmed to increase the vibration torque gain as the estimated value increases.

A motor device according to an example embodiment of the present disclosure includes the control device and the motor.

An electric power steering device according to an example embodiment of the present disclosure includes the motor device, and a steering mechanism including the input shaft, the output shaft, and the torsion bar.

A control method according to an example embodiment of the present disclosure is a method of controlling, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft. The control method includes generating an input torque to be input to the control target based on a torsion bar torque generated in the torsion bar, executing a model following control to generate a correction torque to correct the input torque based on a nominal model based on a configuration of the control target, generating a vibration torque based on a command signal from the vehicle, adjusting a vibration torque gain to be multiplied by the vibration torque, adding the vibration torque multiplied by the vibration torque gain to the input torque, and constraining a transfer function of the control target to a transfer function of the nominal model in a frequency band in which a complementary sensitivity gain is substantially 1 by the model following control, the complementary sensitivity gain being a gain in a gain characteristic of a complementary sensitivity function with respect to a modeling error between the control target and the nominal model. The model following control includes calculating an estimated value of a self-aligning torque to be applied to the control target, and generating the correction torque based on the estimated value. The adjusting the vibration torque gain includes increasing the vibration torque gain as the estimated value increases.

A non-transitory computer-readable medium including a computer program according to an example embodiment of the present disclosure causes a computer to execute the control method described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically illustrating an electric power steering device according to an example embodiment of the present disclosure.

FIG. 2 is a block diagram illustrating a configuration of a control device according to an example embodiment of the present disclosure.

FIG. 3 is a functional block diagram illustrating functions of a processor in the control device according to an example embodiment of the present disclosure.

FIG. 4 is a illustrating an example of a relationship between a steering angle and a base assist torque according to an example embodiment of the present disclosure.

FIG. 5 is a block diagram illustrating a portion of a model following controller in the control device according to an example embodiment of the present disclosure.

FIG. 6 is a graph illustrating a gain characteristic of a complementary sensitivity function and a gain characteristic of a reciprocal of a modeling error between a transfer function of a control target and a transfer function of a nominal model according to an example embodiment of the present disclosure.

FIG. 7 is a graph illustrating an example of a relationship between a steering angle and a self-aligning torque according to an example embodiment of the present disclosure.

FIG. 8 is a block diagram illustrating a gain adjuster according to an example embodiment of the present disclosure.

FIG. 9 is a graph illustrating an example of gain information according to an example embodiment of the present disclosure.

### DETAILED DESCRIPTION

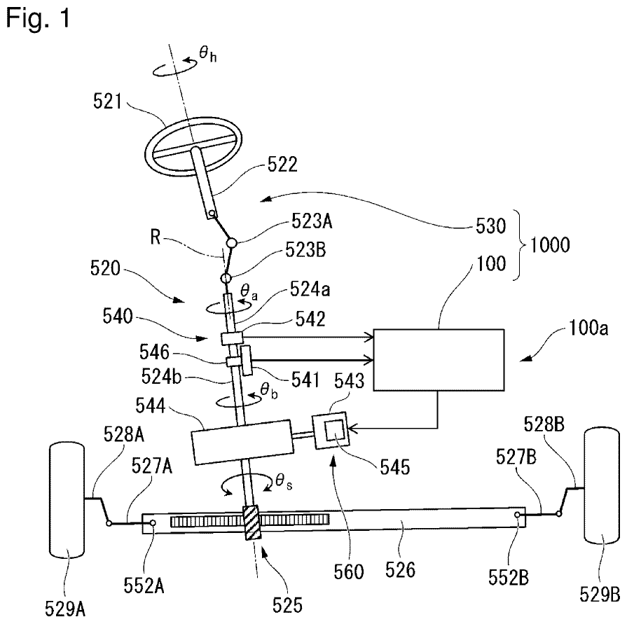

An electric power steering device 1000 of a present example embodiment illustrated in FIG. 1 is mounted on a vehicle. As illustrated in FIG. 1, the electric power steering device 1000 includes a steering mechanism 530 and a control device 100. The steering mechanism 530 includes a steering mechanism unit 520 and an auxiliary mechanism unit 540. The electric power steering device 1000 controls the auxiliary mechanism unit 540 by the control device 100 to generate an auxiliary torque that assists a steering torque Tₕ generated in the steering mechanism unit 520 when a driver who drives the vehicle steers a steering wheel 521. The auxiliary torque reduces the burden of the driver's operation when the driver operates the steering wheel 521. The driver of the vehicle is a steering person who steers the steering wheel 521 of the vehicle.

The steering mechanism unit 520 includes the steering wheel 521, a steering shaft 522, universal joints 523A and 523B, an input shaft 524a, an output shaft 524b, a rack and pinion mechanism 525, a rack shaft 526, right and left ball joints 552A and 552B, tie rods 527A and 527B, knuckles 528A and 528B, and right and left tires 529A and 529B. That is, the steering mechanism 530 includes the steering wheel 521, the steering shaft 522, the universal joints 523A and 523B, the input shaft 524a, the output shaft 524b, the rack and pinion mechanism 525, the rack shaft 526, the right and left ball joints 552A and 552B, the tie rods 527A and 527B, the knuckles 528A and 528B, and the right and left tires 529A and 529B.

The steering shaft 522 is a shaft extending from the steering wheel 521 steered by a steering person. One end portion of the input shaft 524a is connected to an end portion of the steering shaft 522 on a side opposite to a side connected to the steering wheel 521 via the universal joints 523A and 523B. As a result, the steering wheel 521 is connected to the input shaft 524a via the universal joints 523A and 523B and the steering shaft 522. The output shaft 524b is connected to the input shaft 524a via a torsion bar 546 described later. More specifically, one end portion of the output shaft 524b is connected to another end portion of the input shaft 524a via the torsion bar 546. The other end portion of the output shaft 524b is connected to the rack shaft 526 via the rack and pinion mechanism 525.

The input shaft 524a and the output shaft 524b are coaxially arranged. The input shaft 524a and the output shaft 524b are rotatable about the same central axis. The input shaft 524a and the output shaft 524b are relatively rotatable with respect to each other in a range in which the torsion bar 546 described later can be twisted.

The auxiliary mechanism unit 540 includes a steering torque sensor 541, a steering angle sensor 542, a motor 543, a deceleration mechanism 544, an inverter 545, and the torsion bar 546. That is, the steering mechanism 530 includes the steering torque sensor 541, the steering angle sensor 542, the motor 543, the deceleration mechanism 544, the inverter 545, and the torsion bar 546. The torsion bar 546 connects the input shaft 524a and the output shaft 524b. The torsion bar 546 is arranged coaxially with the input shaft 524a and the output shaft 524b. In the description below, a virtual axis passing through a common central axis of the input shaft 524a, the output shaft 524b, and the torsion bar 546 is referred to as a rotation axis R. The torsion bar 546 can be twisted around the rotation axis R.

The steering torque sensor 541 detects the steering torque Tₕ in the steering mechanism unit 520 by detecting the amount of torsion around the rotation axis R of the torsion bar 546. The steering torque Tₕ is a torsion bar torque generated in the torsion bar 546, and is torsional moment around the rotation axis R. The steering angle sensor 542 can detect a rotation angle θₐ around the rotation axis R of the input shaft 524a. The rotation angle θₐ of the input shaft 524a is equal to a steering angle θₕ of the steering wheel 521. That is, the steering angle sensor 542 can detect the steering angle θₕ of the steering wheel 521 by detecting the rotation angle θₐ of the input shaft 524a. A rotation angle θ_{b} of the output shaft 524b can be detected based on the steering torque sensor 541 and the steering angle sensor 542. The rotation angle θ_{b} of the output shaft 524b is a steering angle θₛ.

The inverter 545 converts DC power into three-phase AC power having U-phase, V-phase, and W-phase pseudo sine waves in accordance with a motor driving signal input from the control device 100, and supplies the power to the motor 543. The motor 543 is connected to the output shaft 524b via the deceleration mechanism 544. The three-phase AC power is supplied from the inverter 545 to the motor 543. The motor 543 is, for example, an interior permanent magnet synchronous motor (IPMSM), a surface mounted permanent magnet synchronous motor (SPMSM), a switched reluctance motor (SRM), or the like. When the three-phase AC power is supplied from the inverter 545, the motor 543 generates an auxiliary torque according to the steering torque Tₕ. The motor 543 transmits the generated auxiliary torque to the output shaft 524b via the deceleration mechanism 544.

The control device 100 controls a portion including at least the motor 543 of the steering mechanism 530 mounted on the vehicle, as the control target 560. In the present example embodiment, the control target 560 includes the steering mechanism unit 520, the torsion bar 546, the motor 543, and the deceleration mechanism 544. Since the control target 560 includes the input shaft 524a and the output shaft 524b that can rotate relative to each other via the torsion bar 546, the motion of the control target 560 cannot be described only by a simple equation of motion of the one-inertia system. The control target 560 changes between the one-inertia system and the two-inertia system depending on the strength with which the steering person grips the steering wheel 521. The stronger the steering person grips the steering wheel 521, the closer the control target 560 is to the one-inertia system. The weaker the steering person grips the steering wheel 521, the closer the control target 560 is to the two-inertia system. As described above, the control target 560 includes the two-inertia system.

The control device 100 is electrically connected to the inverter 545. The control device 100 generates a motor driving signal based on the detection signals detected by the steering torque sensor 541, the steering angle sensor 542, a vehicle speed sensor 300 mounted on a vehicle, and the like, and outputs the motor driving signals to the inverter 545. The control device 100 controls the control target 560 by controlling the rotation of the motor 543 via the inverter 545. More specifically, the control device 100 controls the switching operation of a plurality of switching elements included in the inverter 545. Specifically, the control device 100 generates a control signal for controlling the switching operation of each switching element and outputs the control signal to the inverter 545. Each switching element is, for example, a metal-oxide-semiconductor field-effect transistor (MOSFET). In the description below, a control signal: for controlling the switching operation of each switching element is referred to as a “gate control signal”.

The control device 100 generates a torque command value based on the steering torque Tₕ and the like, and controls the torque of the motor 543 and the rotation speed of the motor 543 by means of, for example, vector control. The vector control is a method in which current flowing through the motor 543 is separated into a current component that contributes to generation of a torque and a current component that contributes to generation of a magnetic flux, and the current components orthogonal to each other are independently controlled. The control device 100 may perform not only the vector control but also another piece of closed-loop control. A rotational speed of the motor 543 is expressed by, for example, a rotational speed [revolutions per minute (rpm)] at which a rotor rotates in one minute, a rotational speed [revolutions per second (rps)] at which a rotor rotates in one second, or the like.

Note that a value of the steering torque Tₕ may be directly input to the control device 100 from the steering torque sensor 541, or the control device 100 may calculate a value of the steering torque Tₕ from an output value of the steering torque sensor 541. A value of the steering angle θₕ of the steering wheel 521 may be directly input to the control device 100 from the steering angle sensor 542, or the control device 100 may calculate a value of the steering angle θₕ from an output value of the steering angle sensor 542.

In the present example embodiment, the electric power steering device 1000 includes a motor device 100a. The motor device 100a includes the control device 100, the motor 543, and the inverter 545. The motor device 100a can be manufactured and sold independently of a portion other than the motor device 100a of the electric power steering device 1000. In addition, the control device 100 can be manufactured and sold as a control device for controlling the electric power steering device 1000 independently of a portion other than the control device 100 of the motor device 100a.

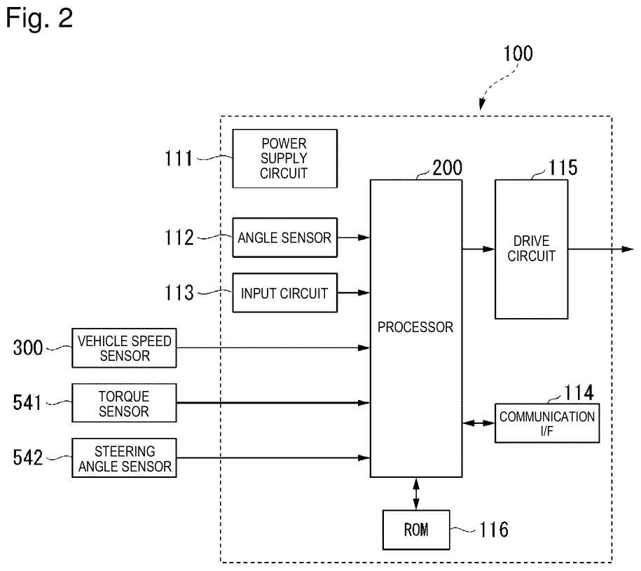

FIG. 2 illustrates a typical example of the configuration of the control device 100 according to the present example embodiment. The control device 100 includes a power supply circuit 111, an angle sensor 112, an input circuit 113, a communication I/F 114, a driving circuit 115, a ROM 116, and a processor 200, for example. The control device 100 may be realized as a printed circuit board (PCB) on which these electronic components are mounted.

In the processor 200, the vehicle speed sensor 300, the steering torque sensor 541, and the steering angle sensor 542 mounted on the vehicle are connected to the processor 200 such that signals can be input to the processor 200. The processor 200 receives the vehicle speed from the vehicle speed sensor 300. The processor 200 receives the steering torque Tₕ from the steering torque sensor 541. The processor 200 receives the steering angle θₕ from the steering angle sensor 542.

The processor 200 is a semiconductor integrated circuit, and is also referred to as a central processing unit (CPU) or a microprocessor. The processor 200 sequentially executes computer programs which are stored in the ROM 116 and describe commands for controlling motor driving, and realizes desired processing. In addition to the processor 200 or instead of the processor 200, the control device 100 may include a field programmable gate array (FPGA) equipped with a CPU, a graphics processing unit (GPU), an application specific integrated circuit (ASIC), an application specific standard product (ASSP), or a combination of two or more circuits selected from these circuits. The processor 200 sets a current command value according to the actual current value, the rotation angle of the rotor of the motor 543, and the like, generates a pulse width modulation (PWM) signal, and outputs the PWM signal to the driving circuit 115.

The power supply circuit 111 is connected to an external power supply (not illustrated). The power supply circuit 111 generates DC voltage necessary for each unit of the control device 100. The DC voltage generated in the power supply circuit 111 is, for example, 3 V or 5 V.

The angle sensor 112 detects a rotation angle of the rotor in the motor 543, and outputs the rotation angle to the processor 200. The angle sensor 112 may be a resolver, a Hall element such as a Hall IC, or an MR sensor having a magnetoresistive element. The processor 200 can calculate an angular velocity ω [rad/s] of the motor 543 based on an electrical angle of the motor 543 obtained based on the angle sensor 112. Note that the control device 100 may include, instead of the angle sensor 112, a speed sensor capable of detecting a rotational angular velocity of the motor 543 and an acceleration sensor capable of detecting a rotational angular acceleration of the motor 543.

A motor current value detected by a current sensor (not illustrated) is input to the input circuit 113. In the description below, a motor current value detected by a current sensor (not illustrated) is referred to as an “actual current value”. The input circuit 113 converts the level of an input actual current value into an input level of the processor 200 as necessary, and outputs the actual current value to the processor 200. A typical example of the input circuit 113 is an analog-digital conversion circuit.

The communication I/F 114 is an input and output interface for transmitting and receiving data in conformity with an in-vehicle controller area network (CAN), for example.

The driving circuit 115 is typically a gate driver or a pre-driver. The driving circuit 115 generates a gate control signal in accordance with a PWM signal, and gives the gate control signal to gates of a plurality of switching elements included in the inverter 545. For example, when the motor 543 to be driven is a motor that can be driven at a low voltage, the driving circuit 115 as a gate driver is not necessarily required in some cases. In that case, the function of the gate driver in the driving circuit 115 may be implemented in the processor 200.

The ROM 116 is electrically connected to the processor 200. The ROM 116 is a writable memory, a rewritable memory, or a read-only memory, for example. Examples of the writable memory include a programmable read only memory (PROM). Examples of the rewritable memory include a flash memory, an electrically erasable programmable read only memory (EEPROM), and the like. The ROM 116 stores therein a control program including commands for causing the processor 200 to control motor driving. For example, the control program stored in the ROM 116 is once developed in a RAM (not illustrated) at the time of booting.

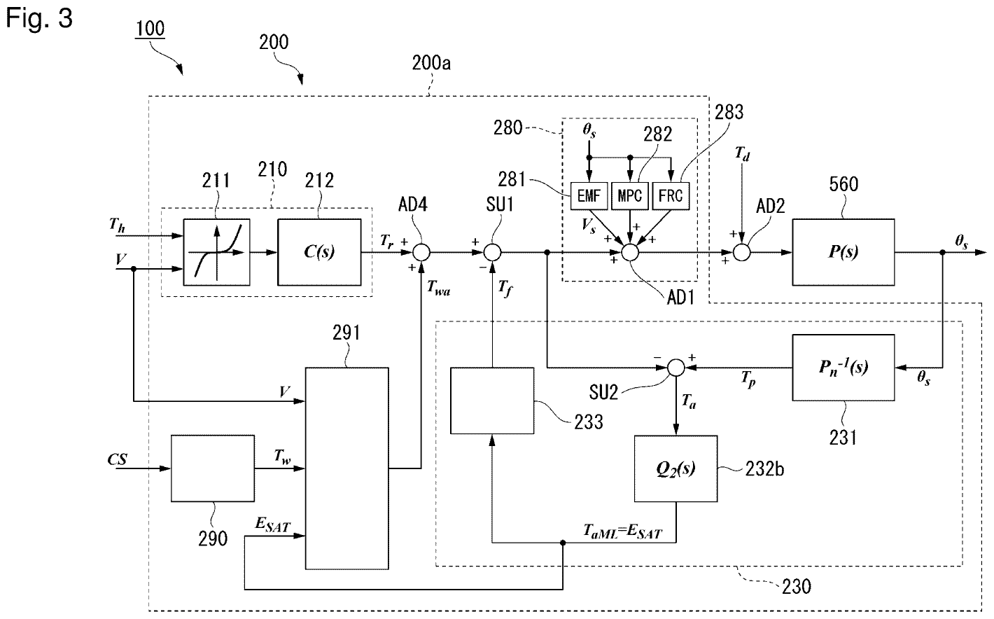

FIG. 3 illustrates an example of functional blocks of the processor 200 according to the present example embodiment. The processor 200, which is a computer, sequentially executes processing or tasks necessary for controlling the motor 543 using each functional block. Each functional block of the processor 200 illustrated in FIG. 3 may be implemented in the processor 200 as software such as firmware, may be implemented in the processor 200 as hardware, or may be implemented in the processor 200 as software and hardware. The processing of each functional block in the processor 200 is typically described in a computer program in units of software modules and stored in the ROM 116. However, in a case where an FPGA or the like is used, all or a portion of the functional blocks may be implemented as a hardware accelerator. A method of controlling the control target 560 according to the present example embodiment is executed by the processor 200, which is a computer, executing a program stored in the control device 100. That is, the program of the present example embodiment stored in the control device 100 causes the processor 200, which is a computer, to execute the method of controlling the control target 560 of the present example embodiment.

The processor 200 includes a controller 200a. The controller 200a includes an assist controller 210, a model following controller 230, a state feedback unit 280, a vibration torque generator 290, a gain adjuster 291, and adder AD4, and a subtractor SU1. That is, the control device 100 includes an assist controller 210, a model following controller 230, a state feedback unit 280, a vibration torque generator 290, a gain adjuster 291, and adder AD4, and a subtractor SU1. In other words, functions corresponding to the assist controller 210, the model following controller 230, the state feedback unit 280, the vibration torque generator 290, the gain adjuster 291, the adder AD4, and the subtractor SU1 are implemented in a processor 200 of the control device 100.

The steering torque Tₕ detected by the steering torque sensor 541 is input to the assist controller 210. The assist controller 210 generates the input torque Tᵣ to be input to the control target 560 based on the steering torque Tₕ, that is, the torsion bar torque generated in the torsion bar 546. In other words, the method of controlling the control target 560 includes generating the input torque Tᵣ to be input to the control target 560 based on the steering torque Tₕ. The input torque Tᵣ is a target torque of the motor 543 and is a torque command value. The assist controller 210 generates the input torque Tᵣ and controls the torque of the motor 543 to thereby control the reaction force transmitted from the steering wheel 521 to the steering person. The assist controller 210 generates the input torque Tᵣ by applying phase compensation to the steering torque Tₕ when the steering frequency or the steering speed is within a predetermined range. The steering frequency is a frequency of the steering angle that changes based on the operation of the steering wheel 521 by the steering person. The steering speed is a speed of the steering angle that changes based on the operation of the steering wheel 521 by the steering person. The assist controller 210 illustrated in FIG. 3 includes a base assist calculation unit 211 and a phase compensator 212.

The base assist calculation unit 211 acquires the steering torque Tₕ and the vehicle speed V. The vehicle speed V is a speed of the vehicle. The base assist calculation unit 211 generates a base assist torque Tₐₛₛ based on the steering torque Tₕ and the vehicle speed V. For example, the base assist calculation unit 211 includes a look-up table (LUT) in which a relationship among the steering torque Tₕ, the vehicle speed V, and the base assist torque Tₐₛₛ is defined. The base assist calculation unit 211 can determine the base assist torque Tₐₛₛ having a correspondence relationship based on the steering torque Tₕ and the vehicle speed V with reference to the look-up table. The base assist calculation unit 211 can determine a base assist gain Kₐₛₛ based on a slope defined by a ratio of a change amount of the base assist torque Tₐₛₛ to the fluctuation amount of the steering torque Tₕ.

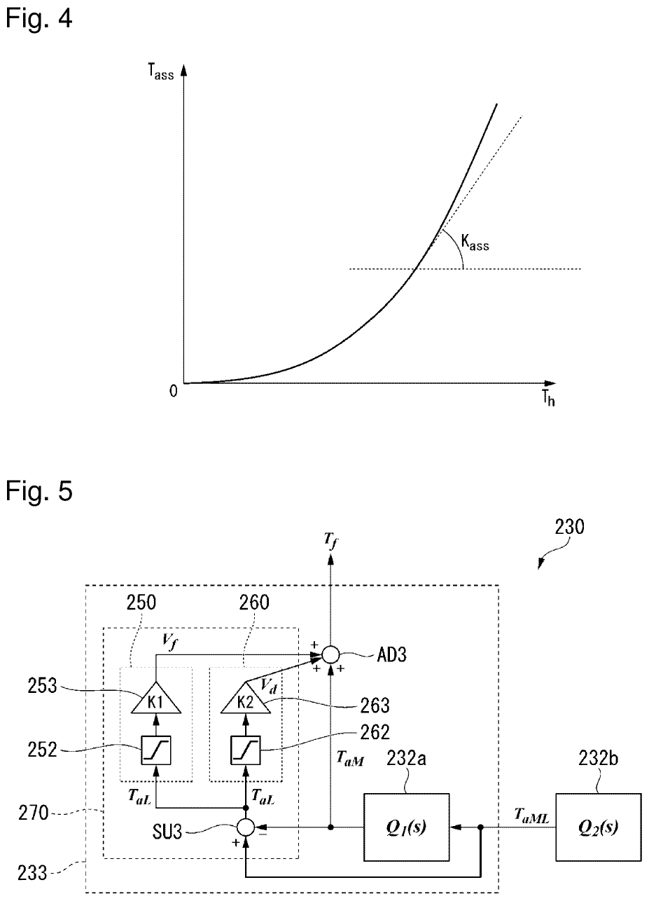

FIG. 4 illustrates an example of a relationship between the steering torque Tₕ and the base assist torque Tₐₛₛ. In the graph of FIG. 4, the horizontal axis represents the steering torque Tₕ, the vertical axis represents the base assist torque Tₐₛₛ, and the inclination of the base assist torque Tₐₛₛ with respect to the steering torque Tₕ is the base assist gain Kₐₛₛ. The steering torque Tₕ, the base assist torque Tₐₛₛ, and the base assist gain Kₐₛₛ satisfy a relationship of dTₐₛₛ/dTₕ=Kₐₛₛ. As illustrated in FIG. 4, the base assist torque Tₐₛₛ increases exponentially as the steering torque Tₕ increases, for example.

The phase compensator 212 in the present example embodiment adjusts the base assist gain Kₐₛₛ within a range of the steering frequency when the driver operates the steering wheel 521, and compensates for the rigidity of the torsion bar 546. The range that a steering frequency can take is, for example, 5 Hz or less. The phase compensator 212 may apply, for example, first-order phase compensation to the steering torque Tₕ, that is, the torsion bar torque, when the steering frequency is 5 Hz or less. The first-order phase compensation is expressed by, for example, a transfer function of Expression (1).

$$\begin{matrix}Expression 1 & \\ C ( s ) = \frac{\frac{1}{2 π {f}_{1}} s + 1}{\frac{1}{2 π {f}_{2}} s + 1} & ( 1 )\end{matrix}$$

In Expression (1), s represents a Laplace transformer, f₁ represents a frequency (Hz) at the zero point of the transfer function, and f₂ represents a frequency (Hz) for determining the pole of the transfer function. A graph in which the gain or loop gain is set as a vertical axis and the logarithm of the frequency is set as a horizontal axis is referred to as a gain diagram. In the gain diagram, the zero point means the intersection of the gain curve and the horizontal axis indicating 0 dB, and the pole means the maximum point of the gain curve. For example, by setting the pole frequency to be higher than the zero point frequency, a phase lead compensation can be applied. The larger the interval between the frequency of the pole and the frequency of the zero point, the larger the phase advance amount.

The phase compensator 212 generates the input torque Tᵣ based on the base assist torque Tₐₛₛ and the base assist gain Kₐₛₛ output from the base assist calculation unit 211. For example, the phase compensator 212 is a stabilization compensator and can apply stability phase compensation to the base assist torque Tₐₛₛ. The phase compensator 212 may have a second-order or higher transfer function whose frequency characteristic is variable according to the base assist gain Kₐₛₛ. The second-order or higher transfer function is expressed using a responsiveness parameter and a damping parameter. The second-order or higher transfer function can be expressed by, for example, Expression (2). By setting the order number of the transfer function to two, damping can be given to the characteristic of the transfer function. A phase characteristic can be adjusted by changing the damping.

$$\begin{matrix}Expression 2 & \\ C ( s ) = \frac{{s}^{2} + 2 {ζ}_{1} {ω}_{1} s + {ω}_{1}^{2}}{{s}^{2} + 2 {ζ}_{2} {ω}_{2} s + {ω}_{2}^{2}} ( \frac{{ω}_{2}^{2}}{{ω}_{1}^{2}} ) & ( 2 )\end{matrix}$$

In Expression (2), s represents a Laplace transformer, ω₁ represents a frequency at the zero point of the transfer function, ω₂ represents a frequency of a pole of the transfer function, ζ₁ represents a damping ratio of the zero point, and ζ₂ represents a damping ratio of the pole. The pole frequency ω₂ is lower than the zero point frequency ω₁.

As illustrated in FIG. 3, the input torque Tᵣ output from the assist controller 210 is input to the adder AD4. The adder AD4 adds a vibration torque T_{wa}, to be described later, to the input torque Tᵣ and outputs the result to the subtractor SU1.

The model following controller 230 generates the correction torque T_{f} for correcting the input torque Tᵣ based on the nominal model based on the configuration of the control target 560. In the present example embodiment, the correction torque T_{f} is a feedback torque fed back to the input torque Tᵣ. The nominal model is an internal model used as a model that constrains the control target 560 when controlling the control target 560. The nominal model will be described in detail later. The model following controller 230 is a controller configured to perform model following control. The method of controlling the control target 560 includes executing model following control to generate the correction torque T_{f} for correcting the input torque Tᵣ based on the nominal model based on the configuration of the control target 560. A specific configuration of the model following controller 230 will be described in detail later.

The subtractor SU1 subtracts a correction torque T_{f} output from the model following controller 230 from the input torque Tᵣ output from the adder AD4. The output from the subtractor SU1 is input to the adder AD1 and the model following controller 230. The adder AD1 outputs a value obtained by adding the output from the state feedback unit 280 to the output from the subtractor SU1, to the adder AD2. The adder AD2 outputs a value obtained by adding a disturbance torque T_{d} to the output from the adder AD1, to the control target 560.

The disturbance torque T_{d} is a difference between the actual output torque of the motor 543 and the ideal output torque of the motor 543. The disturbance torque T_{d} includes a disturbance torque externally applied to the control target 560. The disturbance torque T_{d} includes, for example, an extra torque generated by friction and backlash due to mechanical elements such as the motor 543 and the deceleration mechanism 544, a torque ripple generated in the motor 543, a self-aligning torque T_{SAT}, a disturbance torque that may be generated when traveling on an unpaved rattling road, a gravel road, or the like, and the steering torque Tₕ.

In the present example embodiment, the model following controller 230 generates the correction torque T_{f} based on the steering angle θₛ, and feeds back the correction torque T_{f} to the input torque Tᵣ. The model following controller 230 includes an inverse nominal model 231, a correction torque generator 233, a second filter 232b, and a subtractor SU2. As illustrated in FIG. 5, the correction torque generator 233 includes an assist adjustment unit 270, a first filter 232a, and an adder AD3. In the present example embodiment, the first filter 232a is a high-pass filter. The first filter 232a has a first cutoff frequency Cf1. The first cutoff frequency Cf1 is, for example, 2 Hz or higher and 10 Hz or lower. In the present example embodiment, the first cutoff frequency Cf1 is higher than 5 Hz and lower than 10 Hz.

In the present example embodiment, the second filter 232b is a low-pass filter. The second filter 232b has a second cutoff frequency Cf2 higher than the first cutoff frequency Cf1. The second cutoff frequency Cf2 is, for example, 3 Hz or higher and 50 Hz or lower. However, an upper limit of the second cutoff frequency Cf2 may be set in a range of about 140 Hz or higher and 200 Hz or lower. The order of the second filter 232b is third order or more. The second filter 232b may include, for example, a plurality of low-pass filters. The first filter 232a and the second filter 232b are coupled in series.

The model following controller 230 is configured such that a transfer function P(s) of the control target 560 is constrained to a transfer function Pₙ(s) of the nominal model in a frequency band in which a complementary sensitivity gain GT that is a gain in the gain characteristic of a complementary sensitivity function T(s) with respect to a modeling error between the control target 560 and the nominal model is substantially 1. In other words, the control method of the present example embodiment includes constraining the transfer function P(s) of the control target 560 to the transfer function Pₙ(s) of the nominal model in the frequency band in which the complementary sensitivity gain GT is substantially 1, by the model following control. “The complementary sensitivity gain GT is substantially 1” includes, for example, the case where the complementary sensitivity gain GT is 0.8 or more and 1.2 or less, in addition to the case where the complementary sensitivity gain GT is 1. The numerical range is, for example, a range in which a gain of a substantial disturbance reduction characteristic can be adjusted to 1 in consideration of positive efficiency and reverse efficiency of a worm gear in the case where the deceleration mechanism 544 connected to the motor 543 includes the worm gear. Since efficiency of the worm gear is about 0.8, it is necessary to adjust the gain by ±0.2 with respect to the target value 1.

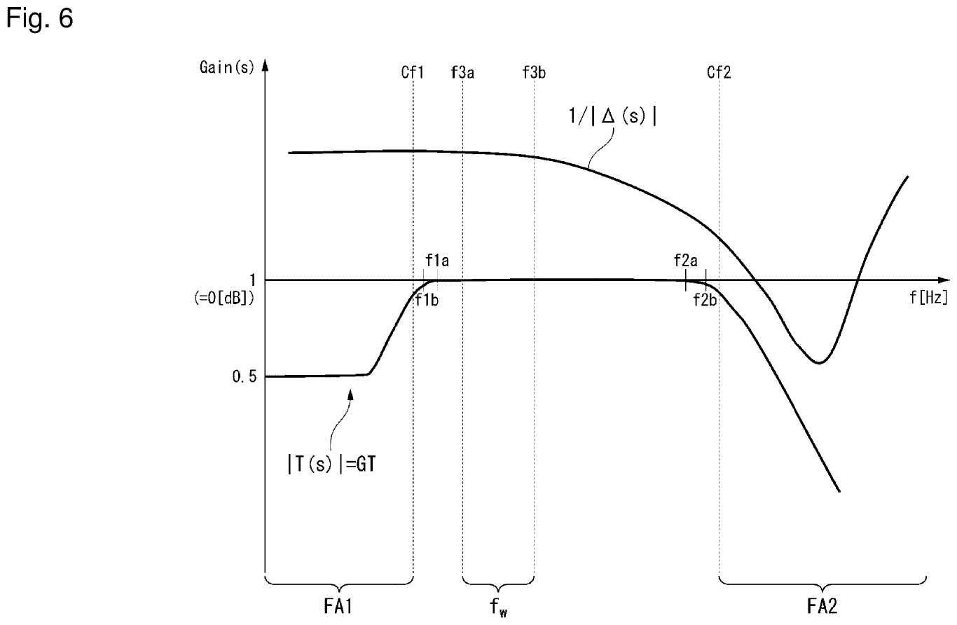

The complementary sensitivity function T(s) is a complementary sensitivity function of an inner loop including the model following controller 230. FIG. 6 illustrates the complementary sensitivity gain GT in the complementary sensitivity function T(s). The complementary sensitivity gain GT is a gain of the complementary sensitivity function T(s) as a transfer function, and is an absolute value of the complementary sensitivity function T(s). In the graph of FIG. 6, the horizontal axis represents the frequency f [Hz], and the vertical axis represents the complementary sensitivity gain GT. As illustrated in FIG. 6, in the complementary sensitivity function T(s), the gain is substantially 0 dB in at least a portion of the frequency band where the frequency f is equal to or higher than the first cut-off frequency Cf1 and equal to or lower than the second cut-off frequency Cf2, that is, the complementary sensitivity gain GT in the transfer function is substantially 1. In the example of FIG. 6, the complementary sensitivity gain GT is 1 in a frequency band that is equal to or higher than the frequency f1a higher than the first cut-off frequency Cf1 and equal to or lower than the frequency f2a lower than the second cut-off frequency Cf2. The frequency f1a is lower than the frequency f2a. In the frequency band of the frequency f1a or higher and the frequency f2a or lower, the complementary sensitivity gain GT may be, for example, a value of 0.95 or larger and smaller than 1. The complementary sensitivity gain GT at the first cutoff frequency Cf1 is smaller than the complementary sensitivity gain GT at the frequency f1a. The complementary sensitivity gain GT at the second cutoff frequency Cf2 is smaller than the complementary sensitivity gain GT at the frequency f2a. In the present example embodiment, the frequency band in which the complementary sensitivity gain GT is substantially 1 is a frequency band of the frequency f1b or higher and the frequency f2b or lower. The frequency f1b is higher than the first cutoff frequency Cf1 and lower than the frequency f1a. The frequency f2b is lower than the second cutoff frequency Cf2 and higher than the frequency f2a. In the frequency band of the frequency f1b or higher and the frequency f2b or lower, the complementary sensitivity gain GT is, for example, 0.8 or larger and 1 or smaller. Note that, in the present description, “a transfer function of a control target is constrained to a transfer function of a nominal model” means that, for example, a control target is controlled such that a transfer function of the control target appears to be a transfer function of a nominal model apparently when an input and output relationship is viewed.

The transfer function P(s) of the control target 560 is a plant characteristic on which the model following control is performed. The transfer function P(s) of the control target 560 is expressed by, for example, Expression (3) below.

$$\begin{matrix}Expression 3 & \\ P ( s ) = \frac{1}{{Js}^{2} + Bs + {K}_{SAT}} & ( 3 )\end{matrix}$$

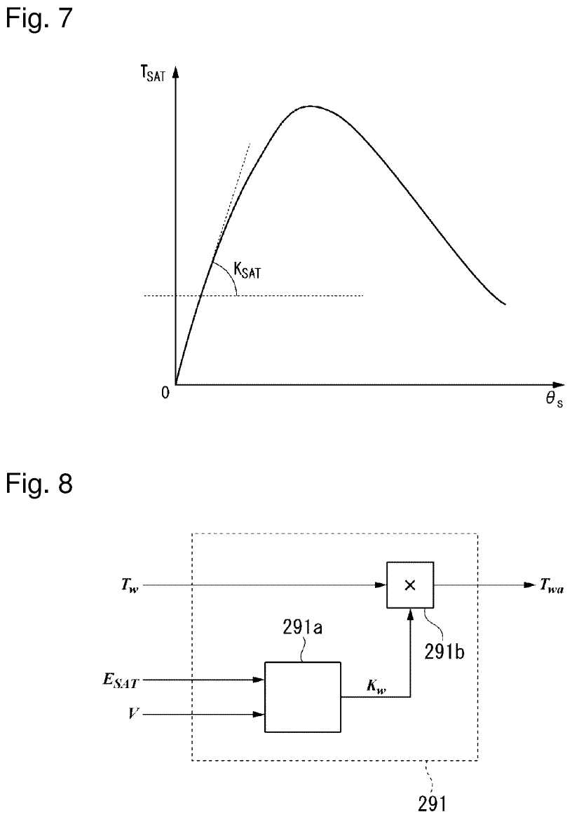

Here, s represents a Laplace transformer, J is a parameter representing the moment of inertia of the steering mechanism unit 520, and B is a parameter representing a viscous friction coefficient of the steering mechanism unit 520. K_{SAT} represents a self-aligning torque gain. The self-aligning torque gain K_{SAT} is an inclination of the self-aligning torque T_{SAT} generated in the tires 529A and 529B of the vehicle with respect to the steering angle θₛ. FIG. 7 illustrates an example of the relationship between the self-aligning torque T_{SAT} and the steering angle θₛ. In the graph of FIG. 7, the horizontal axis represents the steering angle θₛ, the vertical axis represents the self-aligning torque T_{SAT}, and the inclination of the self-aligning torque T_{SAT} with respect to the steering angle θₛ is the self-aligning torque gain K_{SAT}. The steering angle θₛ, the self-aligning torque T_{SAT}, and the self-aligning torque gain K_{SAT} satisfy the relationship of dT_{SAT}/dθₛ=K_{SAT}. As illustrated in FIG. 7, for example, the self-aligning torque T_{SAT} becomes larger as the steering angle θₛ becomes larger up to a certain degree of the steering angle θₛ, and becomes smaller as the steering angle θₛ becomes larger when the steering angle θₛ becomes a certain degree or more.

The inverse nominal model 231 is an inverse model of a predetermined nominal model used to constrain the control target 560. The transfer function Pₙ(s) of the nominal model is expressed by, for example, Expression (4) below. A transfer function Pₙ⁻¹(s) of the inverse nominal model 231 is expressed by, for example, Expression (5) below.

$$\begin{matrix}Expression 4 & \\ {P}_{n} ( s ) = \frac{1}{{J}_{n} {s}^{2} + {B}_{n} s} & ( 4 )\end{matrix}$$

$$\begin{matrix}Expression 5 & \\ {P}_{n}^{- 1} ( s ) = {J}_{n} {s}^{2} + {B}_{n} s & ( 5 )\end{matrix}$$

In Expressions (4) and (5), s represents a Laplace transformer, Jn is a parameter representing the inertia moment of the nominal model, and Bn is a parameter representing the viscous friction coefficient of the nominal model. Note that the transfer function Pn(s) of the nominal model and the transfer function Pn−1(s) of the inverse nominal model 231 are not limited to the examples illustrated in Expressions (4) and (5), and are not particularly limited.

As illustrated in FIG. 3, the output from the control target 560 is input to the inverse nominal model 231. In the present example embodiment, the steering angle θs is input to the inverse nominal model 231. That is, in the present example embodiment, the steering angle θs is input to the model following controller 230 as an output of the control target 560. The inverse nominal model 231 outputs the torque Tp based on Expression (5) described above and the input steering angle θs. That is, the model following controller 230 calculates the torque Tp using the nominal model based on the output of the control target 560. The torque Tp is equal to the value of the torque input to the nominal model when the output value of the nominal model is the same value as the output value of the control target 560.

The subtractor SU2 subtracts the output from the subtractor SU1 from the output of the inverse nominal model 231 to generate a differential torque Ta. That is, the subtractor SU2 generates the differential torque Ta by subtracting, from the torque Tp, the input torque Tr before a state compensation value Vs described later is fed back after the correction torque Tf is fed back. In the present example embodiment, the input torque Tr input to the subtractor SU1 is the input torque Tr after the vibration torque Twa to be described later is added, and the correction torque Tf is subtracted from the input torque Tr in the subtractor SU1. Therefore, the output from the subtractor SU1 is the input torque Tr after the vibration torque Twa to be described later is added and the correction torque Tf is subtracted. In the present example embodiment, the differential torque Ta is an estimated value of the disturbance torque Td.

The differential torque Ta output from the subtractor SU2 is input to the second filter 232b and undergoes low-pass filter processing. The differential torque Ta output from the second filter 232b is a frequency component TaML from which a frequency component higher than the second cutoff frequency Cf2 is removed. In the present example embodiment, the frequency component TaML is an estimated value ESAT of the self-aligning torque TSAT applied to the control target 560. As described above, in the present example embodiment, the model following controller 230 calculates the estimated value ESAT based on the difference (differential torque Ta) obtained by subtracting the input torque Tr after the addition of the vibration torque Twa to be described later from the output (torque Tp) from the inverse nominal model 231. In other words, the model following control includes calculating the estimated value ESAT based on the difference obtained by subtracting the input torque Tr after the vibration torque Twa is added, from the output from the inverse nominal model 231.

In the present specification, the “estimated value ESAT of the self-aligning torque TSAT” only needs to be a value that can be regarded as an estimated value of the self-aligning torque TSAT, and may be an estimated value of a value including a disturbance other than the self-aligning torque TSAT. The value that can be regarded as the estimated value of the self-aligning torque TSAT includes, for example, a case where the proportion of the self-aligning torque TSAT is the largest among the proportions of the disturbance in the value. The frequency component TaML in the present example embodiment includes, as disturbances other than the self-aligning torque TSAT, a frictional force, a disturbance torque caused by backlash of the control target 560, a torque ripple generated in the control target 560, and the like.

The frequency component TaML output from the second filter 232b, that is, the estimated value ESAT, is input to the correction torque generator 233 and the gain adjuster 291. As illustrated in FIG. 5, the frequency component TaML input to the correction torque generator 233 is input to the first filter 232a and subjected to high-pass filter processing. The frequency component TaML subjected to the filter processing by the first filter 232a is input to the adder AD3. The torque input from the first filter 232a to the adder AD3 is subjected to filter processing by the first filter 232a and the second filter 232b with respect to the differential torque Ta output from the subtractor SU2, and a frequency component lower than the first cutoff frequency Cf1 and a frequency component higher than the second cutoff frequency Cf2 are removed. That is, the torque input from the first filter 232a to the adder AD3 is a frequency component TaM equal to or higher than the first cutoff frequency Cf1 and equal to or lower than the second cutoff frequency Cf2 in the differential torque Ta output from the subtractor SU2.

The assist adjustment unit 270 generates a compensation value for friction and disturbance and adjusts the differential torque Ta. In the present example embodiment, the assist adjustment unit 270 adjusts the frequency component TaM in the differential torque Ta. The assist adjustment unit 270 is coupled in parallel to the first filter 232a. The assist adjustment unit 270 includes a friction compensation value calculation unit 250, a disturbance compensation value calculation unit 260, and a subtractor SU3.

The subtractor SU3 subtracts an output value from the first filter 232a, from an output value from the second filter 232b. Here, the output value from the second filter 232b is a value obtained by removing a frequency component higher than the second cutoff frequency Cf2 from the differential torque Ta, that is, the frequency component TaML. The output value from the first filter 232a is a value obtained by removing a frequency component higher than the second cutoff frequency Cf2 and a frequency component lower than the first cutoff frequency Cf1 from the differential torque Ta, that is, the frequency component TaM. Therefore, the value output from the subtractor SU3 is the frequency component TaL lower than the first cutoff frequency Cf1 in the differential torque Ta. The output of the subtractor SU3 is input to the friction compensation value calculation unit 250 and the disturbance compensation value calculation unit 260. The frequency component TaL includes a frictional force, the self-aligning torque TSAT, the disturbance torque caused by backlash of the control target 560, a torque ripple generated in the control target 560, and the like.

The friction compensation value calculation unit 250 calculates the friction compensation value Vf that compensates at least a portion of the frictional force generated in control target 560, based on the differential torque Ta. As described above, the value from the subtractor SU3 input to the friction compensation value calculation unit 250 is the frequency component TaL lower than the first cutoff frequency Cf1 in the differential torque Ta. Therefore, in the present example embodiment, the friction compensation value calculation unit 250 calculates the friction compensation value Vf based on the component having a frequency lower than the first cutoff frequency Cf1 in the differential torque Ta.

The friction compensation value calculation unit 250 includes a limiter 252 and a gain adjuster 253. The limiter 252 limits the output value from the subtractor SU3. The limiter 252 clips the input value to the upper or lower threshold when the input value exceeds the upper or lower threshold. The gain adjuster 253 multiplies a gain K1 by an output value from the limiter 252. The friction compensation value calculation unit 250 calculates the friction compensation value Vf by applying a limit by the limiter 252 and the gain K1 to a component of a frequency lower than the first cutoff frequency Cf1 in the differential torque Ta. The threshold of the limiter 252 and the value of the gain K1 are determined in advance based on, for example, the frictional force actually generated in the control target 560.

The friction compensation value Vf output from the friction compensation value calculation unit 250 is a value that compensates for at least a portion of the frictional force component included in the frequency component Tal of the differential torque Ta. In general, since appropriate friction is required for the control target 560, the friction compensation value calculation unit 250 calculates a value smaller than the frictional force actually generated in the control target 560 as the friction compensation value Vf. This makes it possible to achieve highly accurate friction compensation while maintaining an appropriate frictional force on the control target 560. A target of friction compensation using the friction compensation value Vf is, for example, friction of the motor 543, friction of the deceleration mechanism 544, a difference between right and left in friction of the deceleration mechanism 544, and the like.

The vehicle equipped with the electric power steering device 1000 can travel according to a travel mode having an automatic driving mode and a manual driving mode. In this case, the gain K1 of the gain adjuster 253 may be switched according to the travel mode. The greater the gain K1 of the gain adjuster 253, the greater the degree of friction reduction. The gain K1 in the automatic driving mode is preferably larger than the gain K1 set in the manual driving mode. As a result, it is possible to apply optimum friction compensation to an automatic driving mode in which a reduction in friction is more required.

The disturbance compensation value calculation unit 260 calculates a disturbance compensation value Vd for compensating at least a portion of the self-aligning torque TSAT generated in the control target 560. In the present example embodiment, the disturbance compensation value Vd includes a compensation value for compensating at least a portion of the frictional force generated in the control target 560, the disturbance torque caused by the backlash generated in the control target 560, and the torque ripple generated in the control target 560. The disturbance compensation value calculation unit 260 calculates the disturbance compensation value Vd based on the differential torque Ta that is a difference between the torque Tp output from the inverse nominal model 231 and the input torque Tr. That is, the disturbance compensation value calculation unit 260 calculates the disturbance compensation value Vd based on the differential torque Ta that is a difference between the torque Tp calculated using the nominal model based on the output of the control target 560 and the input torque Tr. As described above, the value from the subtractor SU3 input to the disturbance compensation value calculation unit 260 is a frequency component lower than the first cutoff frequency Cf1 in the differential torque Ta. Therefore, in the present example embodiment, the disturbance compensation value calculation unit 260 calculates the disturbance compensation value Vd based on a component having a frequency lower than the first cutoff frequency Cf1 in the differential torque Ta.

The disturbance compensation value calculation unit 260 includes a limiter 262 and a gain adjuster 263. The limiter 262 limits the output value from the subtractor SU3. The limiter 262 clips the input value to the upper or lower threshold when the input value exceeds the upper or lower threshold. The threshold of the limiter 262 is different from the threshold of the limiter 252, for example. The gain adjuster 263 multiplies a gain K2 by an output value from the limiter 262. The maximum value of the gain K2 of the gain adjuster 263 is determined under the condition that the transfer function P(s) of the control target 560 is constrained to the transfer function Pn(s) of the nominal model. The value of the gain K2 is different from the value of the gain K1, for example. The value of the gain K2 is, for example, about 0.1 or larger and 0.8 or smaller. The gain K2 of the gain adjuster 263 may be switched according to the travel mode of the vehicle.

The disturbance compensation value Vd is a value that compensates for at least a portion of a self-aligning torque component included in the frequency component TaL the differential torque Ta. For example, the disturbance compensation value calculation unit 260 calculates a value corresponding to about half of the self-aligning torque TSAT actually generated in the control target 560, as the disturbance compensation value Vd. The self-aligning torque TSAT actually generated in the control target 560 is experimentally obtained in advance for each frequency, for example. The threshold of the limiter 262 of the disturbance compensation value calculation unit 260 and the value of the gain K2 are adjusted to values at which the disturbance compensation value Vd is calculated as a value about 0.1 times or more and 0.8 times or less the magnitude of the self-aligning torque TSAT obtained in advance. The disturbance compensation value Vd calculated by the disturbance compensation value calculation unit 260 is a value different from the friction compensation value Vf calculated by the friction compensation value calculation unit 250.

Here, the frequency component TaL of the differential torque Ta includes a frictional force generated in the control target 560, the self-aligning torque TSAT generated in the control target 560, a disturbance torque caused by backlash generated in the control target 560, and a torque ripple generated in the control target 560. For this reason, the friction compensation value Vf obtained by processing the frequency component TaL by the limiter 252 and the gain adjuster 253 also includes a compensation value for compensating at least a portion of the disturbance other than the frictional force, that is, the self-aligning torque TSAT generated in the control target 560, the disturbance torque caused by backlash generated in the control target 560, and the torque ripple generated in the control target 560. In addition, the disturbance compensation value Vd obtained by processing the frequency component TaL by the limiter 262 and the gain adjuster 263 also includes a compensation value for compensating at least a portion of the disturbance other than the self-aligning torque TSAT, that is, the frictional force generated in the control target 560, the disturbance torque caused by backlash generated in the control target 560, and the torque ripple generated in the control target 560.

In order to apply friction compensation and disturbance compensation performed in the assist adjustment unit 270 to the correction torque Tf used for model following control in the model following controller 230, it is necessary to pay attention to a stability condition of the model following control. This condition is that the gain in the gain characteristic of the transfer function of the assist adjustment unit 270 constrained to the characteristic considering stability does not exceed 1 according to the small gain theorem described later. This is derived from the design condition of the second filter 232b. In the present example embodiment, the subtractor SU3 is provided in the preceding stage of the limiters 252 and 262 so that the values of the gains K1 and K2 in the gain adjusters 253 and 263 are set to 1 at the maximum and the gain in the gain characteristic becomes 1 under this condition, and subtraction processing is applied. In other words, the assist adjustment unit 270 behaves as a low-pass filter having a transfer function of 1−Q1(s). Q1(s) is a transfer function of the first filter 232a that is a high-pass filter. The assist adjustment unit 270 performs low-pass filter processing having a transfer function of 1−Q1(s) on the torque output from the second filter 232b, and adjusts the value applied with the processing in each of the friction compensation value calculation unit 250 and the disturbance compensation value calculation unit 260 and outputs the value.

The adder AD3 adds an output value from the assist adjustment unit 270 to an output value from the first filter 232a. That is, the adder AD3 adds the friction compensation value Vf and the disturbance compensation value Vd to the frequency component TaM. The adder AD3 outputs the correction torque Tf calculated by adding the frequency component TaM, the friction compensation value Vf, and the disturbance compensation value Vd. The correction torque Tf output from the adder AD3 is fed back to the input of the control target 560, that is, the input torque Tr. As described above, in the present example embodiment, the model following controller 230 generates the correction torque Tf by adding the friction compensation value Vf and the disturbance compensation value Vd to the differential torque Ta from which a frequency component lower than the first cutoff frequency Cf1 is removed by the first filter 232a which is a high-pass filter, that is, the frequency component TaM.

As described above, the model following controller 230 generates the correction torque Tf based on the frequency component TaML of the differential torque Ta that is the estimated value ESAT. In other words, the model following control includes generating the correction torque Tf based on the frequency component TaML of the differential torque Ta that is the estimated value ESAT.

The state feedback unit 280 illustrated in FIG. 3 feeds back the state compensation value Vs to the input torque Tr based on the output of the control target 560 so that the apparent transfer function of the control target 560 approaches the transfer function Pn(s) of the nominal model. The apparent transfer function of the control target 560 is, for example, a transfer function of one portion in a case where a portion located inside a feedback loop formed by the model following controller 230 is regarded as the one portion. Specifically, in the present example embodiment, the apparent transfer function of the control target 560 is a transfer function of the entire portion from the subtractor SU1 to the output of the control target 560, and is a transfer function of a portion combining the state feedback unit 280 and the control target 560. In the present example embodiment, the state feedback unit 280 feeds back the state compensation value Vs to the input torque Tr after being corrected by the correction torque Tf and before being input to the control target 560.

The state compensation value Vs includes a compensation value that compensates at least a portion of the inertial force generated in the control target 560, the viscous force generated in the control target 560, and the frictional force generated in the control target 560. More specifically, the state compensation value Vs includes a compensation value that compensates at least a portion of the inertial force generated in the motor 543, the viscous force generated in the motor 543, and the frictional force generated in the motor 543. In the present example embodiment, the state compensation value Vs is a compensation value including the inertial force generated in the motor 543, the viscous force generated in the motor 543, and the frictional force generated in the motor 543.

The state feedback unit 280 includes an inertia compensator 281, a viscosity compensator 282, and a friction compensator 283. The inertia compensator 281 calculates a compensation value for compensating at least a portion of the inertial force generated in the motor 543 based on the steering angle θs. The viscosity compensator 282 calculates a compensation value for compensating at least a portion of the viscous force generated in the motor 543 based on the steering angle θs. The friction compensator 283 calculates a compensation value for compensating at least a portion of the frictional force generated in the motor 543 based on the steering angle θs. In the present example embodiment, the state compensation value Vs includes a compensation value calculated by the inertia compensator 281, a compensation value calculated by the viscosity compensator 282, and a compensation value calculated by the friction compensator 283. The compensation value calculated by the inertia compensator 281, the compensation value calculated by the viscosity compensator 282, and the compensation value calculated by the friction compensator 283 are output to the adder AD1 and added to the input torque Tr having been corrected by the correction torque Tf.

The vibration torque generator 290 generates the vibration torque Tw based on the command signal CS from the vehicle. That is, the method of controlling the control target 560 includes generating the vibration torque Tw based on the command signal CS from the vehicle. The command signal CS is a signal input from a lane departure warning system (LDWS) (not illustrated) mounted on the vehicle, to the control device 100. When it is determined that the vehicle is likely to deviate from the lane based on an imaging device or the like that images a road surface, the lane deviation warning device sends a command signal CS for instructing the vibration torque generator 290 to generate the vibration torque Tw. The vibration torque Tw generated by the vibration torque generator 290 is input to the gain adjuster 291.

The vibration torque Tw is a torque having a predetermined amplitude and vibrating at a predetermined frequency fw. In the present example embodiment, the value of the predetermined frequency fw is determined within a range from the lower limit value f3a to the upper limit value f3b inclusive illustrated in FIG. 6. The lower limit value f3a is, for example, 10 Hz. The upper limit value f3b is, for example, 30 Hz. That is, the predetermined frequency fw ranges from 10 Hz to 30 Hz inclusive, for example. As illustrated in FIG. 6, the lower limit value f3a of the predetermined frequency fw and the upper limit value f3b of the predetermined frequency fw are higher than the first cutoff frequency Cf1 and lower than the second cutoff frequency Cf2. The lower limit value f3a of the predetermined frequency fw and the upper limit value f3b of the predetermined frequency fw are higher than the frequency f1a and lower than the frequency f2a. For example, the absolute value of the difference between the predetermined frequency fw and the first cut-off frequency Cf1 is smaller than the absolute value of the difference between the predetermined frequency fw and the second cut-off frequency Cf2. The complementary sensitivity gain GT at the frequency fw of the vibration torque Tw is 0.5 or more and 1 or less. In the present example embodiment, the complementary sensitivity gain GT at the frequency fw of the vibration torque Tw is substantially 1. In the example of FIG. 6, the complementary sensitivity gain GT at the frequency fw of the vibration torque Tw is 1. The complementary sensitivity gain GT at the frequency fw of the vibration torque Tw may be 0.95 or more and less than 1.

The gain adjuster 291 adjusts the vibration torque gain Kw to be multiplied by the vibration torque Tw. That is, the method of controlling the control target 560 includes adjusting the vibration torque gain Kw to be multiplied by the vibration torque Tw. As illustrated in FIG. 3, the vehicle speed V, the vibration torque Tw, and the estimated value ESAT are input to the gain adjuster 291. As illustrated in FIG. 8, the gain adjuster 291 includes a gain calculation unit 291a and a multiplier 291b.

The gain calculation unit 291a receives the estimated value ESAT and the vehicle speed V. The gain calculation unit 291a calculates the vibration torque gain Kw corresponding to the estimated value ESAT based on the gain information GI indicating the relationship between the estimated value ESAT and the vibration torque gain Kw. That is, the gain adjuster 291 calculates the vibration torque gain Kw corresponding to the estimated value ESAT based on the gain information GI. In other words, adjusting the vibration torque gain Kw includes calculating the vibration torque gain Kw corresponding to the estimated value ESAT based on the gain information GI.

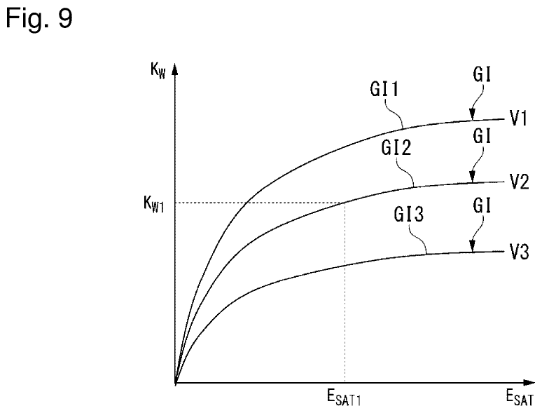

FIG. 9 is a graph illustrating an example of gain information GI. In FIG. 9, the horizontal axis represents the estimated ESAT, and the vertical axis represents the vibration torque gain Kw. As illustrated in FIG. 9, the relationship between the estimated value ESAT and the vibration torque gain Kw indicated by the gain information GI according to the present example embodiment is a relationship in which the vibration torque gain Kw is logarithmically proportional to the estimated value ESAT. The vibration torque gain Kw increases as the estimated value ESAT increases. That is, the gain adjuster 291 increases the vibration torque gain Kw as the estimated value ESAT increases. In other words, adjusting the vibration torque gain Kw by the gain adjuster 291 includes increasing the vibration torque gain Kw as the estimated value ESAT increases.

The gain information GI is determined based on the relationship between the self-aligning torque TSAT and the base assist gain Kass. The waveform of the vibration torque gain Kw with respect to the estimated value ESAT indicated by the gain information GI has a shape similar to the waveform of the base assist gain Kass with respect to the self-aligning torque TSAT. The relationship between the self-aligning torque TSAT and the base assist gain Kass is a relationship in which the base assist gain Kass is logarithmically proportional to the self-aligning torque TSAT. As the self-aligning torque TSAT increases, the base assist gain Kass increases.

In the present example embodiment, a plurality of pieces of gain information GI are provided according to the vehicle speed V. FIG. 9 illustrates the gain information GI in the case where the vehicle speed V is a value V1, the gain information GI in the case where the vehicle speed V is a value V2, and the gain information GI in the case where the vehicle speed V is a value V3. The value V2 increases than the value V1. The value V3 increases than the value V2. The value of the vibration torque gain Kw in the gain information GI2 in the case where the vehicle speed V is the value V2 is smaller than the value of the vibration torque gain Kw in the gain information GI1 in the case where the vehicle speed V is the value V1. The value of the vibration torque gain Kw in the gain information GI3 in the case where the vehicle speed V is the value V3 is smaller than the value of the vibration torque gain Kw in the gain information GI2 in the case where the vehicle speed V is the value V2. That is, the vibration torque gain Kw decreases as the vehicle speed V increases.

The gain calculation unit 291a calculates the vibration torque gain Kw using the gain information GI corresponding to the vehicle speed V. For example, when the vehicle speed V is the value V2 and the estimated value ESAT is the value ESAT1, the gain calculation unit 291a calculates a value Kw1 when the estimated value ESAT is the value ESAT1 in the gain information GI2 as the vibration torque gain Kw. As described above, the gain adjuster 291 calculates the vibration torque gain Kw corresponding to the estimated value ESAT based on the gain information GI corresponding to the current vehicle speed V among the plurality of pieces of gain information GI in the case where the vehicle speeds V are different from each other, in the gain calculation unit 291a. In other words, adjusting the vibration torque gain Kw in the gain adjuster 291 includes calculating the vibration torque gain Kw corresponding to the estimated value ESAT based on the gain information GI corresponding to the current vehicle speed V among the plurality of pieces of gain information GI in the case where the vehicle speeds V are different from each other. Although FIG. 9 illustrates three pieces of gain information GI corresponding to three vehicle speeds V respectively, the number of pieces of gain information GI corresponding to different vehicle speeds V respectively may be two or four or more.

As illustrated in FIG. 8, the vibration torque gain Kw calculated in the gain calculation unit 291a is multiplied by the vibration torque Tw in the multiplier 291b. As a result, the multiplier 291b outputs the vibration torque Twa as the vibration torque Tw in a state multiplied by the vibration torque gain Kw. As illustrated in FIG. 3, the vibration torque Twa output from the gain adjuster 291 is input to the adder AD4. The vibration torque Twa is added to the input torque Tr output from the assist controller 210 in the adder AD4. In this manner, the vibration torque Twa multiplied by the vibration torque gain Kw is added to the input torque Tr.

Next, control by the model following controller 230 will be described in more detail. The model following controller 230 controls the control target 560 using the inverse model of the nominal model as the internal model, that is, the inverse nominal model 231. In the present example embodiment, a torque ripple or the like depending on the angular velocity ω of the motor 543 can be compensated by a feedback loop formed by the model following controller 230.

The model following controller 230 is structurally similar to a conventional disturbance estimator (disturbance observer), but has different actions and effects. A conventional disturbance estimator estimates a disturbance torque by using an inverse plant model as an internal model as a model close to the control target 560, and reduces the influence of disturbance by adjusting the disturbance torque in advance.

The control by the model following controller 230 according to the present example embodiment utilizes the effect that the transfer function P(s) of the control target 560 is constrained to the transfer function Pn(s) of the nominal model as the internal model, by the feedback loop. For example, if the nominal model is defined such that there is no torque ripple, the transfer function P(s) of the control target 560 is constrained to the characteristic without the torque ripple by the model following control, and as a result, the torque ripple can be reduced by applying torque ripple compensation. By setting the nominal model as a low-inertia model and constraining the control target 560 with the nominal model, the control target 560 can be treated as a low-inertia model. The control target 560 can be treated as a low viscosity model by setting the nominal model as a low viscosity model and constraining the control target 560 with the nominal model. By the model following controller 230 executing model following control, for example, lost torque compensation or motor inertia compensation is performed in addition to compensation of the torque ripple of the motor 543. By appropriately setting Jn and Bn in Expressions (4) and (5) described above, a desired frequency characteristic can be given to the transfer function P(s) of the control target 560.

When a modeling error between the transfer function P(s) of the control target 560 and the transfer function Pn(s) of the nominal model is Δ(s), the transfer function P(s) of the control target 560 is expressed by the following Expression (6).

$$\begin{matrix}Expression 6 & \\ P ( s ) = \frac{1}{{J}_{n} {s}^{2} + {B}_{n} s} ( 1 + Δ ( s ) ) & ( 6 )\end{matrix}$$

The gain characteristic of the transfer function P(s) of the control target 560 has peaks in two frequency values, for example. The modeling error Δ(s) appears, for example, near the higher frequency peak of the two peaks in the gain characteristic of the control target 560. For this reason, as illustrated in FIG. 6, the reciprocal 1/Δ(s) of the modeling error Δ(s) has a bottom in a relatively high frequency domain. In FIG. 6, the modeling error Δ(s) is indicated by an absolute value. When the modeling error Δ(s) increases, the deviation between the transfer function P(s) of the control target 560 and the transfer function Pn(s) of the nominal model increases, and the control of the control target 560 using the nominal model by the model following controller 230 becomes unstable. For this reason, in a domain where the modeling error Δ(s) is relatively small, the control target 560 can be stably and suitably controlled by setting the gain of the complementary sensitivity function T(s) to be substantially 1 and constraining the control target 560 to the nominal model. The frequency characteristic of the modeling error Δ(s) can be adjusted by adjusting Jₙ and Bₙ in the transfer function Pₙ(s) of the nominal model. The frequency band where the gain of the complementary sensitivity function T(s) becomes substantially 1 can be adjusted by adjusting the first cutoff frequency Cf1 and the second cutoff frequency Cf2. Consequently, the gain of the complementary sensitivity function T(s) can be adjusted to be substantially 1 in the frequency band where the modeling error Δ(s) is small.

In FIG. 6, 1/Δ(s) is relatively high in a frequency band of the second cutoff frequency Cf2 or less, and rapidly decreases in a frequency band higher than the second cutoff frequency Cf2. The model following control for constraining the control target 560 to the nominal model can be stably performed, for example, in a range where 1/Δ(s) increases than 1, that is, in a range where 1/Δ(s) increases than 0 dB. For this reason, as illustrated in FIG. 6, by adjusting 1/Δ(s) to be larger than 1 in a frequency band in which a gain of the complementary sensitivity function T(s) is substantially 1, in a case where a gain of the complementary sensitivity function T(s) is substantially 1, the control target 560 can be constrained to the nominal model to be stably and suitably controlled.

For example, in order to expand the frequency band where the control target 560 can be stably and suitably controlled by constraining the control target 560 to the nominal model, the second cutoff frequency Cf2 may be increased within a range in which 1/Δ(s) is not 1 or less, that is, within a frequency band lower than a frequency at which a curve indicating 1/Δ(s) in FIG. 6 intersects the horizontal axis. However, if the second cutoff frequency Cf2 is made too high, the gain of the complementary sensitivity function T(s) remains relatively high even though 1/Δ(s) becomes low in a frequency band higher than the second cutoff frequency Cf2, and control may become unstable. On the other hand, in the present example embodiment, since the order of the second filter 232b, which is a low-pass filter, is set to third order or more, the gain of the complementary sensitivity function T(s) can be steeply decreased in a region where the frequency is higher than the second cutoff frequency Cf2. As a result, if the second cutoff frequency Cf2 is made relatively high, the gain of the complementary sensitivity function T(s) can be immediately lowered in a frequency band higher than the second cutoff frequency Cf2, so that control of the control target 560 can be prevented from becoming unstable.

Robust stability of the model following controller 230 is guaranteed when the small-gain theorem shown in Expression (7) below is established between the complementary sensitivity function T(s) and the modeling error Δ(s).

$$\begin{matrix}Expression 7 & \\ \vert < \frac{1}{\vert Δ ( j ω ) \vert} , , \vert T ( j ω ) Δ ( j ω ) \vert < 1 , ∀ s = j ω & ( 7 )\end{matrix}$$

As described above, in order to perform model following control using the nominal model in the model following controller 230, the complementary sensitivity gain GT of the complementary sensitivity function T(s) may be substantially 1, but in consideration of robust stability, it is necessary to satisfy Expression (7) above. As understood from this, it is not possible to achieve both setting of the complementary sensitivity gain GT to substantially 1 in all frequency bands and Expression (7), and it is not possible to achieve both reduction in disturbance or the like by the model following controller 230 and robust stability.

As illustrated in FIG. 6, the complementary sensitivity gain GT of the complementary sensitivity function T(s) is smaller than 1 also in a low frequency domain FA1 where the frequency f is lower than the first cutoff frequency Cf1. In a region where the complementary sensitivity gain GT of the complementary sensitivity function T(s) is smaller than 1, the assist controller 210 controls the input torque Tᵣ to control the control target 560. As described above, in a high frequency domain FA2 where the frequency is higher than the second cutoff frequency Cf2, the complementary sensitivity gain GT of the complementary sensitivity function T(s) is greatly lowered, and the correction torque T_{f} from the model following controller 230 is hardly fed back to the input of the control target 560. On the other hand, in the low frequency domain FA1, the complementary sensitivity gain GT of the complementary sensitivity function T(s) is set to a certain magnitude, and the correction torque T_{f} is fed back to the input of the control target 560. In the low frequency domain FA1, a compensation value generated in the assist adjustment unit 270 described above is fed back to the input of the control target 560 according to the complementary sensitivity gain GT of the complementary sensitivity function T(s). In the present example embodiment, the value of the complementary sensitivity gain GT in the low frequency domain FA1 is 0.5 or more. In the present example embodiment, a stationary gain T(0) of the complementary sensitivity function T(s) is 0.5.

A transfer function F(s) from the vibration torque T_{wa} to the steering torque Tₕ applied to the input torque Tᵣ is expressed by, for example, the Expression (8) provided below.

$$\begin{matrix}Expression 8 & \\ F ( s ) = ( \frac{P ( s )}{1 + {C}_{1} ( s ) P ( s )} ) {K}_{tor} & ( 8 )\end{matrix}$$

In Expression (8), C₁(s) represents a transfer function of the assist controller 210, P(s) represents a transfer function of the control target 560, and Kₜₒᵣ represents a spring constant of the torsion bar 546. The gain of the transfer function C₁(s) of the assist controller 210 increases as the base assist gain Kₐₛₛ increases. Therefore, from Expression (8), it can be seen that the gain of the transfer function F(s) decreases as the base assist gain Kₐₛₛ increases and the gain of the transfer function C₁(s) increases. Therefore, it can be seen that the larger the base assist gain Kₐₛₛ, the smaller the vibration torque T_{wa} appearing in the steering torque Tₕ. Therefore, if the magnitude of the vibration torque T_{wa} to be added to the input torque Tᵣ is constant, when the base assist gain Kₐₛₛ changes due to a change in the steering angle θₕ or the like, the magnitude of the vibration torque T_{wa} transmitted to the steering person via the steering wheel 521 changes. Therefore, when the magnitude of the vibration torque T_{wa} added to the input torque Tᵣ is constant, there is a problem that it is difficult for the steering person to accurately grasp the information transmitted by the vibration torque T_{wa}. Specifically, for example, in a case where the vehicle is likely to deviate from the lane, when the steering person turns the steering wheel 521 to change the steering angle θₕ, the magnitude of the vibration torque T_{wa} transmitted to the steering person changes, and the steering person may misrecognize the warning based on the lane deviation warning device.

In view of the above problem, according to the present example embodiment, the control device 100 of the electric power steering device 1000 includes the model following controller 230 that generates the correction torque T_{f} for correcting the input torque Tᵣ based on the nominal model based on the configuration of the control target 560, the vibration torque generator 290 that generates the vibration torque T_{w} based on the command signal CS from the vehicle, and the gain adjuster 291 that adjusts the vibration torque gain K_{w} multiplied by the vibration torque T_{w}. The vibration torque T_{wa} multiplied by the vibration torque gain K_{w} is added to the input torque Tᵣ. The model following controller 230 calculates the estimated value E_{SAT} of the self-aligning torque T_{SAT} applied to the control target 560. The model following controller 230 generates the correction torque T_{f} based on the estimated value E_{SAT}. The gain adjuster 291 increases the vibration torque gain K_{w} as the estimated value E_{SAT} increases. In other words, the control method of controlling the control target 560 includes executing model following control to generate the correction torque T_{f} for correcting the input torque Tᵣ based on the nominal model based on the configuration of the control target 560, generating the vibration torque T_{w} based on the command signal CS from the vehicle, adjusting the vibration torque gain K_{w} multiplied by the vibration torque T_{w}, and adding the vibration torque T_{wa} multiplied by the vibration torque gain K_{w} to the input torque Tᵣ. The model following control includes calculating the estimated value E_{SAT} of the self-aligning torque T_{SAT} applied to the control target 560 and generating the correction torque T_{f} based on the estimated value E_{SAT}. Adjusting the vibration torque gain K_{w} includes increasing the vibration torque gain K_{w} as the estimated value E_{SAT} increases.

Therefore, the vibration torque T_{wa} can be increased as the estimated value E_{SAT} of the self-aligning torque T_{SAT} increases. As a result, the vibration torque T_{wa} can be increased as the self-aligning torque T_{SAT} increases and the base assist gain Kₐₛₛ increases. Therefore, even when the base assist gain Kₐₛₛ increases and the gain of the transfer function F(s) from the vibration torque T_{wa} to the steering torque Tₕ decreases, it is possible to suppress a change in the magnitude of the vibration torque T_{wa} appearing in the steering torque Tₕ. Therefore, even if the self-aligning torque T_{SAT} changes, it is possible to suppress a change in the magnitude of the vibration torque T_{wa} transmitted to the steering person. As a result, no matter how the steering person steers the vehicle when the vehicle is likely to deviate from the lane, the magnitude of the vibration torque T_{wa} transmitted to the steering person can be suppressed from changing, and the steering person can easily and accurately grasp the information transmitted by the vibration torque T_{wa}. In addition, since the control target 560 can be constrained to the nominal model by the model following control, the base assist gain Kₐₛₛ in the assist controller 210 can be reduced as a whole as compared with the case where the model following control is not performed. As a result, it is possible to suppress a decrease in the gain of the transfer function F(s), and it is possible to suppress a decrease in the vibration torque T_{w} transmitted to the steering person. In addition, the frequency f_{w} of the vibration torque T_{wa} transmitted to the steering person is a frequency in a frequency band that hardly affects the steering of the vehicle performed by the steering person. In a frequency band in which the steering of the vehicle is hardly affected, the disturbance is compensated by the model following control. Therefore, by executing the model following control, a disturbance having a frequency in the frequency band is compensated, and it is possible to suppress a disturbance having a frequency similar to the frequency f_{w} of the vibration torque T_{wa} from being transmitted to the steering person. As a result, the vibration torque T_{wa} transmitted to the steering person can be suppressed from being obstructed by the disturbance. Therefore, the vibration torque T_{wa} can be easily transmitted to the steering person. Furthermore, when the model following control is performed, it is necessary to estimate a disturbance. Therefore, by obtaining the estimated value E_{SAT} of the self-aligning torque T_{SAT} using the disturbance estimated in the model following control, it is not necessary to separately obtain the value of the base assist gain Kₐₛₛ, and it is possible to suppress an increase in the calculation load of the control device 100.

According to the present example embodiment, the model following controller 230 includes the inverse nominal model 231 that is an inverse model of the nominal model and to which the output from the control target 560 is input, and calculates the estimated value E_{SAT} of the self-aligning torque T_{SAT} based on the difference obtained by subtracting the input torque Tᵣ after the addition of the vibration torque T_{wa} from the output from the inverse nominal model 231, that is, the difference torque Tₐ. In other words, the model following control includes calculating the estimated value E_{SAT} based on the difference obtained by subtracting the input torque Tᵣ after the vibration torque T_{wa} is added, from the output from the inverse nominal model 231. Therefore, the estimated value E_{SAT} of the self-aligning torque T_{SAT} can be generated based on the difference between the input and output to the control target 560. As a result, the model following controller 230 can accurately calculate the estimated value ESAT of the self-aligning torque T_{SAT}. Therefore, the vibration torque gain K_{w} can be easily changed with high accuracy in accordance with the change in the self-aligning torque T_{SAT}. Therefore, it is possible to further suppress a change in the magnitude of the vibration torque T_{wa} transmitted to the steering person.

According to the present example embodiment, the gain adjuster 291 calculates the vibration torque gain K_{w} corresponding to the estimated value E_{SAT} based on the gain information GI indicating the relationship between the estimated value E_{SAT} and the vibration torque gain K_{w}. In other words, adjusting the vibration torque gain K_{w} includes calculating the vibration torque gain K_{w} corresponding to the estimated value E_{SAT} based on the gain information GI indicating the relationship between the estimated value E_{SAT} and the vibration torque gain K_{w}. Therefore, the vibration torque gain K_{w} can be easily calculated based on the gain information GI. In addition, by setting the relationship between the estimated value E_{SAT} and the vibration torque gain K_{w} indicated by the gain information GI to a relationship similar to the relationship between the self-aligning torque T_{SAT} and the base assist gain Kₐₛₛ, the vibration torque gain K_{w} can be changed similarly to the change of the base assist gain Kₐₛₛ. As a result, the magnitude of the vibration torque T_{wa} can be accurately changed in accordance with the change in the base assist gain Kₐₛₛ, and the change in the magnitude of the vibration torque T_{wa} transmitted to the steering person can be further suppressed.

According to the present example embodiment, the gain adjuster 291 calculates the vibration torque gain K_{w} corresponding to the estimated value E_{SAT} based on the gain information GI corresponding to the current vehicle speed among the plurality of pieces of gain information GI in the case where the vehicle speeds are different from each other. In other words, adjusting the vibration torque gain K_{w} includes calculating the vibration torque gain K_{w} corresponding to the estimated value E_{SAT} based on the gain information GI corresponding to the current vehicle speed among the plurality of pieces of gain information GI in the case where the vehicle speeds are different from each other. Therefore, the vibration torque gain K_{w} can be changed in accordance with the base assist gain Kₐₛₛ that changes according to the change in the vehicle speed V. As a result, the magnitude of the vibration torque T_{wa} can be more accurately changed in accordance with the change in the base assist gain Kₐₛₛ. Therefore, it is possible to further suppress a change in the magnitude of the vibration torque T_{wa} transmitted to the steering person.

According to the present example embodiment, the relationship between the estimated value E_{SAT} and the vibration torque gain K_{w} indicated by the gain information GI is a relationship in which the vibration torque gain K_{w} is logarithmically proportional to the estimated value E_{SAT}. By setting the gain information GI to such information, the relationship between the estimated value E_{SAT} and the vibration torque gain K_{w} indicated by the gain information GI can be easily made similar to the relationship between the self-aligning torque T_{SAT} and the base assist gain Kₐₛₛ. As a result, by using the gain information GI, the vibration torque gain K_{w} can be calculated more accurately in accordance with the change in the base assist gain Kₐₛₛ. Therefore, it is possible to further suppress a change in the magnitude of the vibration torque T_{wa} transmitted to the steering person.

According to the present example embodiment, the complementary sensitivity gain GT at the frequency f_{w} of the vibration torque T_{wa} is 0.5 or more and 1 or less. Therefore, at the frequency f_{w} of the vibration torque T_{wa}, more than half of the disturbance can be compensated by the model following control. As a result, the disturbance having the frequency f_{w} can be compensated to a certain extent or more by the model following control, and the vibration torque T_{wa} transmitted to the steering person can be suitably suppressed from being obstructed by the disturbance having the frequency f_{w}. In the present example embodiment, the complementary sensitivity gain GT at the frequency f_{w} of the vibration torque T_{wa} is substantially 1. Therefore, at the frequency f_{w} of the vibration torque T_{wa}, the disturbance can be completely or almost completely compensated by the model following control. As a result, it is possible to more preferably suppress the vibration torque T_{wa} transmitted to the steering person from being obstructed by the disturbance having the frequency f_{w}.

At least a portion of the function of each component of the control device 100 described above may be implemented by hardware including a circuit unit such as a large scale integration (LSI), an application specific integrated circuit (ASIC), a field-programmable gate array (FPGA), and a graphics processing unit (GPU), or may be implemented by cooperation of software and hardware. A storage unit in which a program for causing the processor 200 of the control device 100, which is a computer, to execute the above-described control method is stored is realized by, for example, a storage medium such as a random access memory (RAM), a read only memory (ROM), a hard disk drive (HDD), or a flash memory. The storage unit is not particularly limited as long as a program for causing a computer to execute the above-described control method can be stored, and may be a microcomputer or a disk medium such as a CD-ROM. The storage unit may be provided separately from the control device 100. In this case, the control device 100 may communicate with the storage unit by wired communication or wireless communication and execute the program stored in the storage unit.

The present disclosure is not limited to the above-described example embodiment, and other configurations and other methods can be employed within the scope of the technical idea of the present disclosure. The model following controller may calculate the estimated value of the self-aligning torque in any manner. The gain adjuster may change the vibration torque gain in any manner with respect to the estimated value of the self-aligning torque as long as the vibration torque gain increases as the estimated value of the self-aligning torque increases. The estimated value of the self-aligning torque may be input to the gain adjuster after the filter processing is performed. The vibration torque gain adjusted by the gain adjuster may be multiplied by the vibration torque generated by the vibration torque generator after the filter processing is performed.

Example embodiments of the present disclosure can have configurations as described below.

[1] A control device that controls, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control device including an assist controller configured or programmed to generate an input torque to be input to the control target based on a torsion bar torque generated in the torsion bar, a model following controller configured or programmed to generate a correction torque to correct the input torque based on a nominal model based on a configuration of the control target, a vibration torque generator configured or programmed to generate a vibration torque based on a command signal from the vehicle, and a gain adjuster configured or programmed to adjust a vibration torque gain to be multiplied by the vibration torque, wherein the vibration torque multiplied by the vibration torque gain is added to the input torque, the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model, the model following controller is configured or programed to calculate an estimated value of a self-aligning torque to be applied to the control target, and generate the correction torque based on the estimated value, and the gain adjuster is configured or programmed to increase the vibration torque gain as the estimated value increases.

[2] The control device according to [1], wherein the model following controller is configured or programmed to include an inverse nominal model that is an inverse model of the nominal model and to which an output from the control target is input, and calculates the estimated value based on a difference obtained by subtracting the input torque after the vibration torque is added, from the output from the inverse nominal model.

[3] The control device according to [1] or [2], wherein the gain adjuster is configured or programed to calculate the vibration torque gain corresponding to the estimated value based on gain information indicating a relationship between the estimated value and the vibration torque gain.

[4] The control device according to [3], wherein the gain adjuster is configured or programed to calculate the vibration torque gain corresponding to the estimated value based on the gain information corresponding to a current speed of the vehicle among a plurality of pieces of the gain information in a case where the speeds of the vehicle are different from each other.

[5] The control device according to [3] or [4], wherein the relationship between the estimated value and the vibration torque gain indicated by the gain information is a relationship in which the vibration torque gain is logarithmically proportional to the estimated value.

[6] The control device according to any one of [1] to [5], wherein the complementary sensitivity gain at a frequency of the vibration torque is about 0.5 or more and about 1 or less.

[7] The control device according to [6], wherein the complementary sensitivity gain at the frequency of the vibration torque is 1 or substantially 1.

[8] A motor device including the control device according to any one of [1] to [7], and the motor.

[9] An electric power steering device including the motor device according to [8], and a steering mechanism including the input shaft, the output shaft, and the torsion bar.

[10] A control method of controlling, as a control target, at least a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control method including generating an input torque to be input to the control target based on a torsion bar torque generated in the torsion bar, executing a model following control to generate a correction torque to correct the input torque based on a nominal model based on a configuration of the control target, generating a vibration torque based on a command signal from the vehicle, adjusting a vibration torque gain to be multiplied by the vibration torque, adding the vibration torque multiplied by the vibration torque gain to the input torque, and constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model, wherein the model following control includes calculating an estimated value of a self-aligning torque to be applied to the control target and generating the correction torque based on the estimated value, and the adjusting the vibration torque gain includes increasing the vibration torque gain as the estimated value increases.

[11] The control method according to [10], wherein the model following control includes calculating the estimated value based on a difference obtained by subtracting the input torque after the vibration torque is added, from the output from an inverse nominal model, the inverse nominal model being an inverse model of the nominal model and to which an output from the control target is input.

[12] The control method according to [10] or [11], wherein the adjusting the vibration torque gain includes calculating the vibration torque gain corresponding to the estimated value based on gain information indicating a relationship between the estimated value and the vibration torque gain.

[13] The control method according to [12], wherein the adjusting the vibration torque gain includes calculating the vibration torque gain corresponding to the estimated value based on the gain information corresponding to a current speed of the vehicle among a plurality of pieces of the gain information in a case where the speeds of the vehicle are different from each other.

[14] The control method according to [12] or [13], wherein the relationship between the estimated value and the vibration torque gain indicated by the gain information is a relationship in which the vibration torque gain is logarithmically proportional to the estimated value.

[15] The control method according to any one of [10] to [14], wherein the complementary sensitivity gain at a frequency of the vibration torque is about 0.5 or more and about 1 or less.

[16] The control method according to [15], wherein the complementary sensitivity gain at the frequency of the vibration torque is 1 or substantially 1.

[17] A non-transitory computer-readable medium includes a program to cause a computer to execute the control method according to any one of [10] to [16].

The configurations and methods described above in the present description can be appropriately combined within a range consistent with each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A control device that controls, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control device comprising:
an assist controller configured or programmed to generate an input torque to be input to the control target based on a torsion bar torque generated in the torsion bar;
a model following controller configured or programmed to generate a correction torque to correct the input torque based on a nominal model based on a configuration of the control target;
a vibration torque generator configured or programmed to generate a vibration torque based on a command signal from the vehicle; and
a gain adjuster configured or programmed to adjust a vibration torque gain to be multiplied by the vibration torque; wherein
the vibration torque multiplied by the vibration torque gain is added to the input torque;
the model following controller is configured or programmed:
such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model;
to calculate an estimated value of a self-aligning torque to be applied to the control target; and
to generate the correction torque based on the estimated value; and
the gain adjuster is configured or programmed to increase the vibration torque gain as the estimated value increases.

2. The control device according to claim 1, wherein the model following controller is configured or programmed to include an inverse nominal model that is an inverse model of the nominal model and to which an output from the control target is input, and calculate the estimated value based on a difference obtained by subtracting the input torque after the vibration torque is added, from the output from the inverse nominal model.

3. The control device according to claim 1, wherein the gain adjuster is configured or programmed to calculate the vibration torque gain corresponding to the estimated value based on gain information indicating a relationship between the estimated value and the vibration torque gain.

4. The control device according to claim 3, wherein the gain adjuster is configured or programmed to calculate the vibration torque gain corresponding to the estimated value based on the gain information corresponding to a current speed of the vehicle among a plurality of pieces of the gain information in a case where the speeds of the vehicle are different from each other.

5. The control device according to claim 3, wherein the relationship between the estimated value and the vibration torque gain indicated by the gain information is a relationship in which the vibration torque gain is logarithmically proportional to the estimated value.

6. The control device according to claim 1, wherein the complementary sensitivity gain at a frequency of the vibration torque is about 0.5 or more and about 1 or less.

7. The control device according to claim 6, wherein the complementary sensitivity gain at the frequency of the vibration torque is 1 or substantially 1.

8. A motor device comprising:
the control device according to claim 1; and
the motor.

9. An electric power steering device comprising:
the motor device according to claim 8; and
a steering mechanism including the input shaft, the output shaft, and the torsion bar.

10. A control method of controlling, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control method comprising:
generating an input torque to be input to the control target based on a torsion bar torque generated in the torsion bar;
executing model following control to generate a correction torque to correct the input torque based on a nominal model based on a configuration of the control target;
generating a vibration torque based on a command signal from the vehicle;
adjusting a vibration torque gain to be multiplied by the vibration torque;
adding the vibration torque multiplied by the vibration torque gain to the input torque; and
constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model; wherein
the model following control includes:
calculating an estimated value of a self-aligning torque to be applied to the control target; and
generating the correction torque based on the estimated value; and
the adjusting the vibration torque gain includes increasing the vibration torque gain as the estimated value increases.
